(19) United States
(12) Patent Application Publication
(10) Pub. No.: US 2020/0250373 A1
(43) Pub. Date: Aug. 6, 2020

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Masaki Yamamichi, Yokohama-shi (JP)

(21) Appl. No.: 16/775,152

(22) Filed: Jan. 28, 2020

(30) Foreign Application Priority Data
Jan. 31, 2019 (JP) 2019-015846

(51) Int. Cl. G06F 40/169; G06F 40/106

(52) U.S. Cl. CPC G06F 40/169; G06F 40/106

(57) ABSTRACT

In a case where a direction in which an object protrudes from a first page is a direction toward a termination position of a character string input by an input unit that is different from a starting position of the character string, the character string input by the input unit is displayed in a state where the character string is shifted in the direction toward the termination position of the character string.

### BACKGROUND

### Field of the Invention

The present disclosure relates to an information processing apparatus that places an object with respect to a page, a control method therefor, and a storage medium therefor.

### Description of the Related Art

A rendering object can be placed with respect to each page of document data, by using a document editing application. Examples of the rendering object include image data such as a bitmap, text data such as a character string, and graphic data such as a quadrangle and a line. Most of these rendering objects are each placed within a page, but a rendering object called an electronic tag (or a tag) among these rendering objects can be placed in a state where a portion thereof protrudes from the page. Therefore, a mark or a memo can be attached to a specific page by using the electronic tag as with a paper tag. Japanese Patent Application Laid-Open No. 2011-043895 discusses an electronic tag that can be placed to have a portion protruding from a page.

### SUMMARY

According to an aspect of the present disclosure, an information processing apparatus includes a display unit that displays a plurality of pages and an object attached to a page among the plurality of pages to have a portion being present outside a region of the page, and the information processing apparatus includes an input unit configured to input a character string to the object to align a starting position of the character string to a side in a direction toward the starting position of the character string, wherein, in a case where a direction in which a portion of the object is present outside a region of a first page from the first page is a direction toward a termination position of the character string that is different from the direction toward the starting position of the character string input by the input unit, the display unit displays the character string input by the input unit and aligned to a side in the direction toward the termination position of the character string.

Further features of the present disclosure will become apparent from the following description of exemplary embodiments with reference to the attached drawings.

### BRIEF DESCRIPTION OF THE DRAWINGS

FIG. 1 is a hardware block diagram of a personal computer (PC) for configuring a document editing application according to one or more aspects of the present disclosure.

FIG. 2 is a software block diagram of the PC for configuring the document editing application according to one or more aspects of the present disclosure.

FIG. 3 illustrates a data structure of document data in the document editing application according to one or more aspects of the present disclosure.

FIG. 4 illustrates data structure of an “annotation object” within annotation data in the document editing application according to one or more aspects of the present disclosure.

FIG. 5 is a diagram illustrating an example of a flowchart about processing in tag placement in a document editing application according to one or more aspects of the present disclosure.

FIG. 6 is a diagram illustrating an example of a user interface of the document editing application according to one or more aspects of the present disclosure.

FIG. 7 is a diagram illustrating an example of placement of a tag in a case where the processing in the tag placement according to one or more aspects of the present disclosure.

FIG. 8 is a diagram illustrating an example of a flowchart about processing in character-string region setting for a tag in a document editing application according to one or more aspects of the present disclosure.

FIG. 9 is a diagram illustrating an example of a flowchart about changing of a start page in the document editing application according to one or more aspects of the present disclosure.

FIG. 10 is a diagram illustrating an example of a user interface for tag annotation placement setting of a document editing application according to one or more aspects of the present disclosure.

FIG. 11 illustrates a data structure of information about tag annotation placement in the document editing application according to one or more aspects of the present disclosure.

FIGS. 12A and 12B are diagrams each illustrating an example of placement of a tag in a case where processing in tag placement according to one or more aspects of the present disclosure.

FIGS. 13A and 13B are diagrams illustrating an example of placement of a tag in a case where processing in changing of the start page according to one or more aspects of the present disclosure.

### DESCRIPTION OF THE EMBODIMENTS

There is a case where a character string is input to an electronic tag in such a manner that the character string is aligned to a side in the starting position of the character string. For example, if the character string is horizontally written, the character string is left-aligned. If the character string is vertically written, the character string is top-aligned.

For example, when the horizontally written character string is input to be left-aligned, the following issue arises if a portion of the electronic tag protrudes from the right edge of a page. Even if the electronic tag is placed to protrude from the right edge of the page, if this page is not displayed as the start page (if this page is covered by another page), the left-aligned input character string is displayed in a state of being hidden by another page. A similar issue can arise in the case of the vertically written character string.

Japanese Patent Application Laid-Open No. 2011-043895 discusses a document processing apparatus that enables a user to confirm a character string on an electronic tag placed on a page other than a displayed page when the user places a cursor on the electronic tag. However, in a configuration discussed in Japanese Patent Application Laid-Open No. 2011-043895, the user cannot confirm a character string other than the character string on the electronic tag on which the cursor is placed. Therefore, the user cannot confirm character strings on all the tags at a time.

The present disclosure is directed to bringing a character string on an electronic tag into view when the character string is hidden in a plurality of pages displayed as a stack, without bothering a user.

Exemplary embodiments of the present disclosure will be described below with reference to the drawings. Each of the exemplary embodiments will be described by using an annotation object (a tag) as an example of a rendering object, but of course another rendering object such as an original-document object may be used.

### [System Configuration]

A first exemplary embodiment will be described. In the present exemplary embodiment, a general information processing apparatus (a personal computer (PC)) implements all functions of a document editing application according to the present exemplary embodiment.

### [Hardware Configuration]

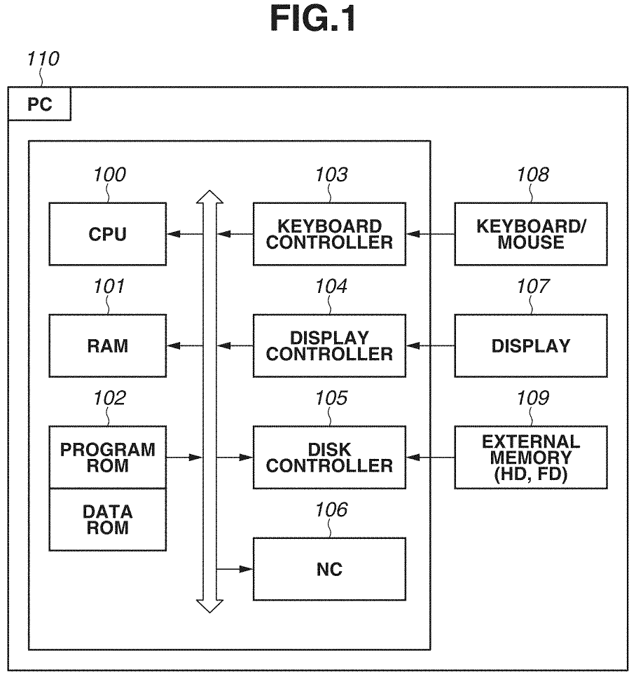

FIG. 1 illustrates a hardware block diagram of a PC for configuring a document editing application according to the present exemplary embodiment of the present disclosure. A hardware configuration illustrated in FIG. 1 corresponds to a hardware configuration of a general information processing apparatus. The hardware configuration of the general information processing apparatus is applicable to the PC (a PC 110) of the present exemplary embodiment.

In FIG. 1, a central processing unit (CPU) 100 executes a program, such as an operating system (OS) or an application, stored in a program read only memory (ROM) of a ROM 102 or loaded from a hard disk 109 into a random access memory (RAM) 101. The CPU 100 executes the program so that processing in each flowchart to be described below is implemented. The RAM 101 serves as a main memory and a work area of the CPU 100. A keyboard controller 103 controls input from a pointing device (not illustrated) such as a keyboard/mouse 108. A display controller 104 controls display on a display 107 of any of various types. A disk controller 105 controls data access in a disk that stores various kinds of data, such as the HD 109 or a floppy (registered trademark) disk (FD). A network controller (NC) 106 is connected to a network and executes processing for controlling communication with other apparatuses connected to the network.

### [Software Configuration]

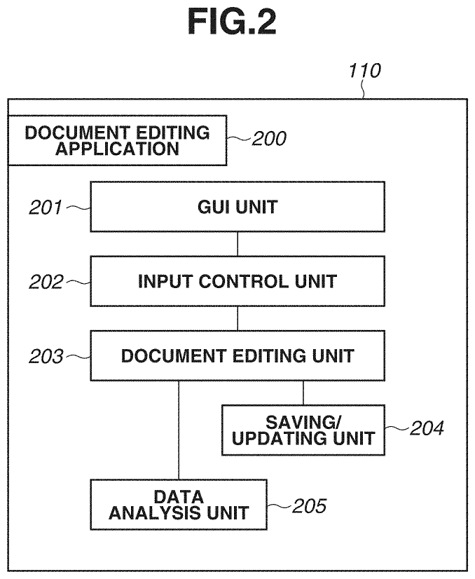

A document editing application 200 installed on the PC 110 will be described with reference to FIG. 2. The document editing application 200 reads document data and provides a user with a function of editing the read document data.

As described with reference to the hardware configuration, the program running on the PC 110 implements all functions of the document editing application 200 according to the present exemplary embodiment.

The document editing application 200 includes a graphical user interface (GUI) unit 201, an input control unit 202, a document editing unit 203, a saving/updating unit 204, and a data analysis unit 205. The GUI unit 201 receives input from an input device such as the keyboard/mouse 108 via a screen displayed on the display 107 of the PC 110.

The input control unit 202 detects a user operation on the keyboard/mouse 108 by using the GUI unit 201, and provides an instruction for editing document data or saving a file, based on the detected operation. The document editing unit 203 controls various kinds of editing processing for the document data being edited by the document editing application 200, based on the editing instruction from the input control unit 202. The saving/updating unit 204 provides an instruction for saving or updating the document data, based on the editing instruction from the input control unit 202. The data analysis unit 205 analyzes the document data and generates a rendering object, based on the control by the document editing unit 203.

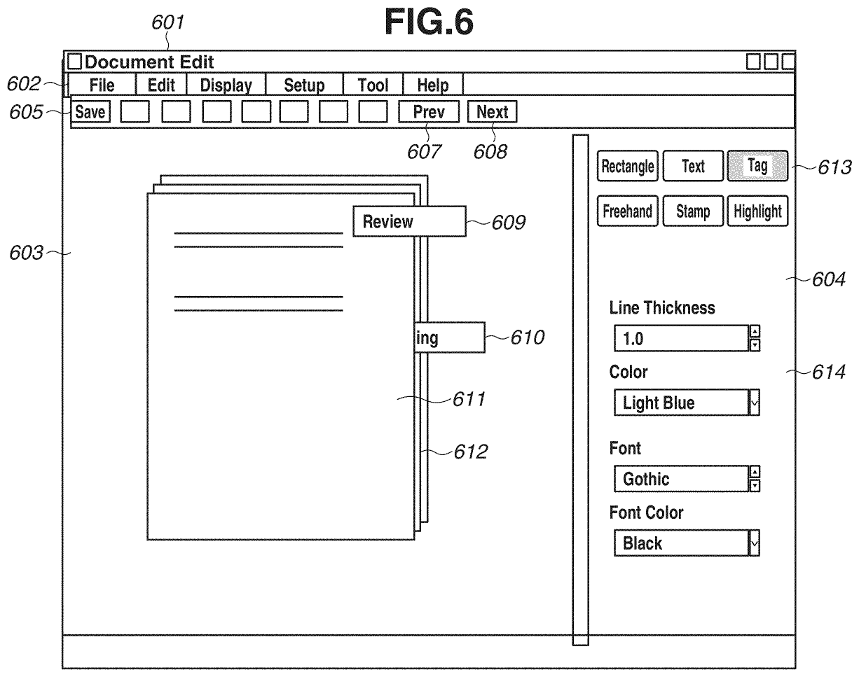

FIG. 6 illustrates an example of a main window 601 displayed by the GUI unit 201 of the document editing application 200. The main window 601 includes a menu/tool bar 602, a page preview 603, and an object pane 604.

Controls for performing various functions of the document editing application 200 are arranged in the menu/tool bar 602. For example, a control 605 for saving document data as a file is present in the menu/tool bar 602. The page preview 603 is a region where the content of document data is rendered, and a state where a page 611 included in a plurality of pages is rendered is illustrated in FIG. 6. Pages (including a page 612) other than the start page are displayed in a state of being slightly displaced from the start page.

The document data displayed in the page preview 603 displays each of a tag 609 and a tag 610 in a state of protruding from the page. These tags can each be placed on any page by using applicable items included in the object pane 604. In the present exemplary embodiment, a rendering object displayed in a state where a partial region of the rendering object protrudes from a page will be referred to as a “tag” for the sake of description. However, the rendering object can be placed within the page not to protrude from the page. Various functions for inserting and editing rendering objects are arranged in the object pane 604. For example, a control 613 for inserting various rendering objects and a control 614 for changing attributes such as color and thickness of a rendering object are present.

### [Data Structure]

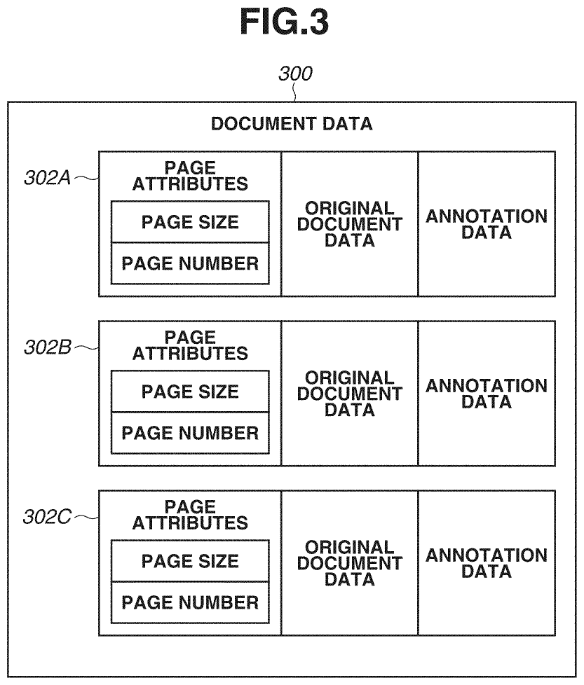

A data structure of document data will be described with reference to FIG. 3. The document data has a structure imitating paper media. Attributes related to the overall document data (document attributes) and page attributes of each page defined by the document editing application are defined in the document data. One piece of document data 300 can include a plurality of pages.

As illustrated in FIG. 3, the document data includes data (original document data and annotation data) for each page. Specifically, the document attributes are defined in the document data 300, and three pages 302A, 302B, and 302C are linked to the document data 300. In each of the pages 302A, 302B, and 302C, the page attributes are defined, and the original document data and the annotation data that form the substance of the page are included.

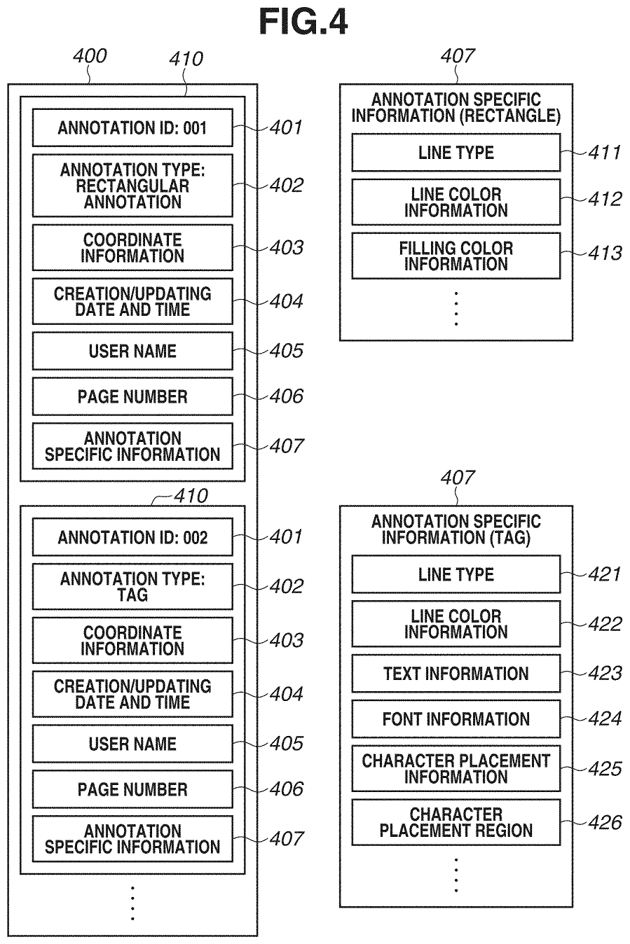

The annotation data included in each page of the document will be described with reference to FIG. 4. The annotation data includes an annotation identification (ID), so that the attribute information of an annotation object included in an annotation object list can be identified by referring to the annotation ID. An annotation object list 400 includes annotation object information 410. The annotation object information 410 includes an annotation ID 401, an annotation type 402, coordinate information 403 indicating the position of an annotation object, and a creation/updating date and time 404 of the annotation object. The annotation object information 410 further includes a user name 405 of a user who has attached the annotation object, a page number 406 of a page to which the annotation object is attached, and annotation specific information 407. The annotation specific information 407 is referred to in a case where the annotation type is “rectangle”. The annotation specific information 407 of a rectangular annotation object holds, for example, a line type 411, line color information 412 indicating the color and transparency of a line, and filling color information 413 indicating the color and transparency of a filling color. The annotation specific information 407 is referred to in a case where the annotation type is “tag”. The annotation specific information 407 of a tag holds, for example, a line type 421, line color information 422, text information 423 indicating what is placed as a character string, font information 424 to be used in rendering of the character string, and character placement information 425 indicating to which position the character string is to be aligned when placed in the tag.

Specifically, in a case where left, right, top, and bottom placement positions are present for a page in the character placement information 425, and a tag is attached in different directions relative to one page, the character placement information 425 is information representing a combination of pieces of information about the respective placement positions (e.g., upper left). A character placement region 426 is a region where a character string can be placed in the entire region of the tag. Such a list structure of the annotation object information 410 is stored in the annotation object list 400.

In the present exemplary embodiment, “tag” and “rectangle” are distinguished from each other and each described as the annotation type. This is because an object in a case where the annotation type is “rectangle” and an object in a case where the annotation type is “tag” are assumed to behave differently. In a case where the object of a “rectangle” type is placed in a page, the object cannot be placed to protrude from the page. On the other hand, in a case where the object of a “tag” type is placed in a page, the object can be placed to protrude from the page. The object of a “rectangle” type may be in a mode of not displaying a portion protruding from the page. The object may not change the behavior when being placed in a page depending on the type of the object. The behavior and distinguishing mode of each object may be changed depending on the type of the document editing application.

### [Flow of Processing in Tag Placement]

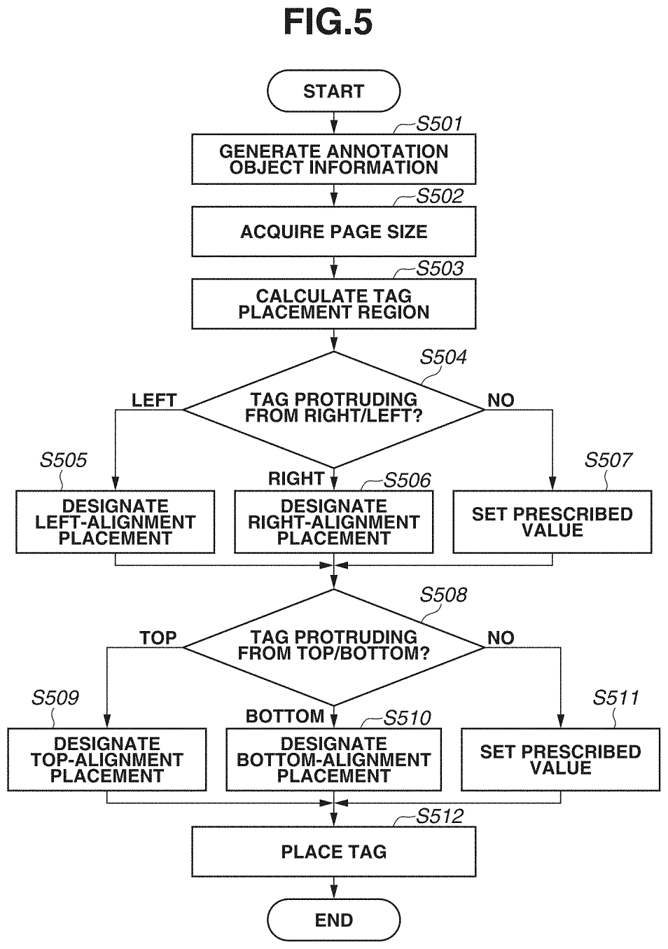

A flow of processing in placing a tag in a document editing application according to the first exemplary embodiment of the present disclosure will be described with reference to FIG. 5, FIG. 6, and the main window 601 of the document editing application 200.

When the control 613 is pressed by the user with the keyboard/mouse 108, and the user performs an operation (e.g., a left-click of the mouse) for inserting a tag at any position of the page preview 603, the GUI unit 201 detects the operation on the keyboard/mouse 108 and provides an instruction corresponding to the operation to the input control unit 202. Upon receiving the instruction, the input control unit 202 instructs the document editing unit 203 to insert the tag based on the operation. Upon being instructed, the document editing unit 203 starts tag placement processing so that the flow in FIG. 5 begins.

In step S501, the document editing unit 203 generates the annotation object information 410, based on a user operation for attaching a tag to a page.

In step S502, the document editing unit 203 acquires a page size from the page attributes of the page 611 displayed as the start page in the page preview 603 and as an editing target.

In step S503, the document editing unit 203 calculates a tag placement region with respect to the page 611. For example, in a case where the tag is inserted by a left-click of the mouse, the tag having a predefined width and height is placed, starting from a left-clicked position.

In step S504, the document editing unit 203 determines whether the tag protrudes from the page in a specific direction, by referring to the page size acquired in step S502 and the tag placement region calculated in step S503. Specifically, the document editing unit 203 determines whether the tag protrudes from the right or the left of the page. In a case where the tag protrudes only from the left, the processing proceeds to step S505. In a case where the tag protrudes only from the right, the processing proceeds to step S506. Otherwise (in a case where the tag protrudes from neither the right nor the left, or in a case where the tag protrudes from both sides), the processing proceeds to step S507. In step S505, the document editing unit 203 designates left-alignment placement in the character placement information 425 of the tag. In step S506, the document editing unit 203 designates right-alignment placement in the character placement information 425 of the tag. In step S507, the document editing unit 203 sets a prescribed value in the character placement information 425 of the tag. Here, the prescribed value may be a value held beforehand by the document editing application 200, or the user may define the prescribed value, using a setting dialog (not illustrated).

In step S508, the document editing unit 203 determines whether the tag protrudes from the top or the bottom of the page, by referring to the page size acquired in step S502 and the tag placement region calculated in step S503. In a case where the tag protrudes only from the top, the processing proceeds to step S509. In a case where the tag protrudes only from the bottom, the processing proceeds to step S510. Otherwise (in a case where the tag protrudes from neither side, or in a case where the tag protrudes from both sides), the processing proceeds to step S511. In step S509, the document editing unit 203 designates top-alignment placement in the character placement information 425 of the tag. In step S510, the document editing unit 203 designates bottom-alignment placement in the character placement information 425 of the tag. In step S511, the document editing unit 203 sets a prescribed value in the character placement information 425 of the tag. Here, the prescribed value may be a value held beforehand by the document editing application 200, or the user may define the prescribed value, using a setting dialog (not illustrated).

In step S512, the document editing unit 203 places the tag at the position calculated in step S503 and the processing ends.

When a new tag is inserted into a page by this processing, the input position of a character string is automatically adjusted such that the character string is aligned to a side in a direction of protrusion from the page. This processing flow is described based on a situation where a new tag is inserted (a state where no text is input). However, a tag in which a character string is already input may be used, or this processing flow may also be applied to a case where the input position of a character string is changed by moving or resizing a tag already placed on a page. This processing flow may also be applied to a new tag generated by a copy operation.

In a case where a tag is already placed on a specific page, it is conceivable that an event that triggers the execution of the flow in FIG. 5 is occurrence of a situation where the page to which the tag is already attached is covered by another page, so that the tag is hidden.

In the present exemplary embodiment, step S504 and step S508 are separately performed each as the processing for determining the direction in which the tag protrudes from the page. However, step S504 and step S508 combined may be performed as a single process.

### [Effects]

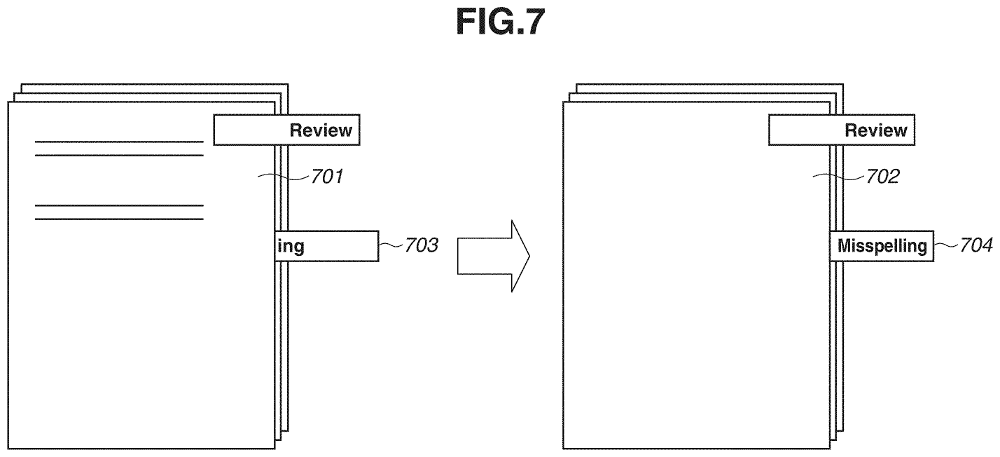

FIG. 7 illustrates an effect of the execution of the processing in the flow in FIG. 5. A tag 703 represents a tag in a case where the flow in FIG. 5 is not applied. The tag 703 is present on a page other than the start page, and the starting position of a character string is hidden by the start page. A tag 704 represents a tag in a case where the flow in FIG. 5 is applied. In the tag 704 placed on a page other than the start page, a right-aligned character string is written (shifted toward the termination position of the character string). Therefore, the user can visually recognize the character string of the tag placed on the page other than the start page, without selecting this page.

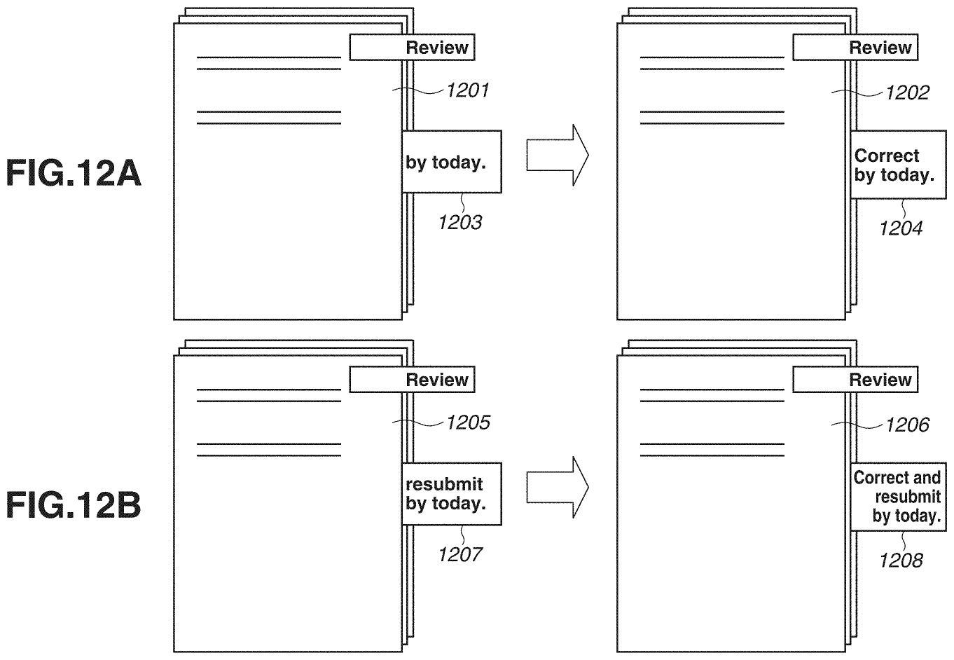

The effect of the first exemplary embodiment is illustrated in FIG. 7, but there is a situation where the character string is partially hidden by the start page depending on the length of the character string, even if the character string is aligned to a side in one direction (a tag 1207 in FIG. 12B). In a second exemplary embodiment, there will be described a mode of preventing a character string from being hidden by the start page even if the character string is long.

[Flow of Processing about Setting of Character Placement Region for Tag]

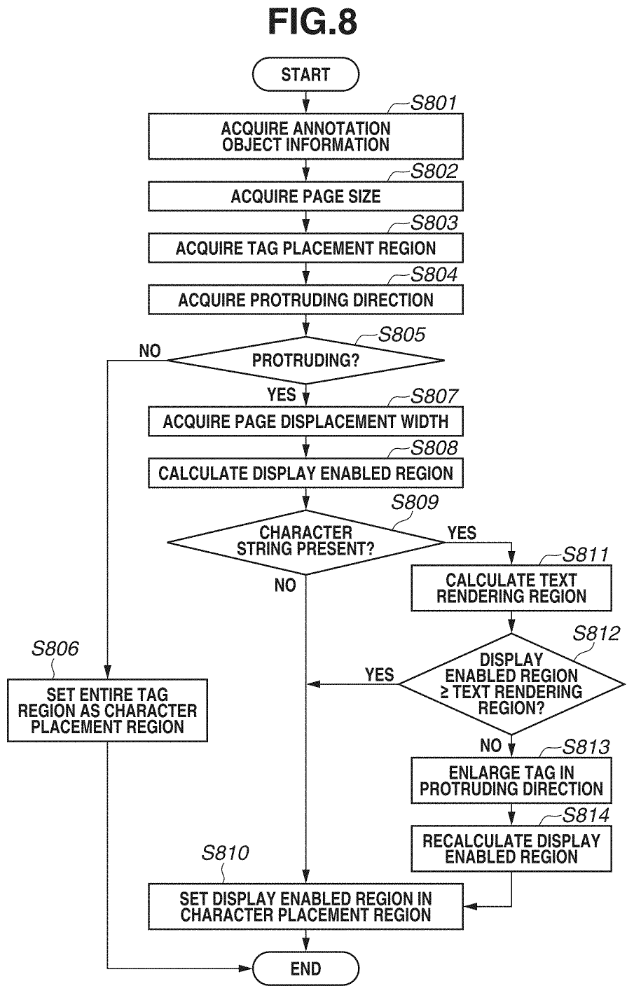

Processing for placing a character string on a tag according to the second exemplary embodiment will be described with reference to FIG. 8. An operation that triggers the processing in FIG. 8 is, for example, an operation for placing a new tag on a page, an operation for changing a placement region such as moving or resizing a tag, or an operation for editing a character string such as adding a character string or changing a font for displaying a character string. This processing flow begins when the user performs any of these operations, so that this processing flow is applied to a tag and a character placement region is set.

For example, in a case where a new tag is to be inserted, when the control 613 is pressed by the user with the keyboard/mouse 108, and the user performs an operation (e.g., a left click of the mouse) for inserting a tag at any position of the page preview 603, the GUI unit 201 detects the operation on the keyboard/mouse 108 and provides an instruction corresponding to the operation to the input control unit 202. Upon receiving the instruction, the input control unit 202 instructs the document editing unit 203 to insert the tag based on the operation. Upon being instructed, the document editing unit 203 starts tag insertion processing so that this processing flow begins.

In a case where a character string on a tag is to be edited, the flow of this processing begins each time the user inputs a character string to or deletes a character string from a tag. Specifically, when the user selects the tag 609 with the keyboard/mouse 108 and performs an operation for editing a character string, the GUI unit 201 detects the operation on the keyboard/mouse 108, and provides an instruction corresponding to the operation to the input control unit 202. Upon receiving the instruction, the input control unit 202 instructs the document editing unit 203 to edit the character string of the tag based on the operation. Upon being instructed, the document editing unit 203 starts character-string editing processing for the tag so that this processing flow begins. The document editing unit 203 performs all the processing in this flow.

In step S801, the document editing unit 203 acquires the annotation object information 410 of the tag that is an operation target. The document editing unit 203 generates the annotation object information 410 in this step when a new tag is inserted, and the document editing unit 203 acquires the annotation object information 410 when an existing tag is edited.

In step S802, the document editing unit 203 acquires a page size from the page attributes of the page 611 that is a target for the insertion of the tag. In step S803, the document editing unit 203 acquires a placement region for the page 611 of the tag that is the operation target. In inserting a new tag, for example, in inserting a tag by a left-click of the mouse, the document editing unit 203 acquires a region having a prescribed value as each of a width and a height, starting from a left-clicked position (upper left). In changing a placement region, the document editing unit 203 calculates a placement region after the tag is moved or resized. In editing a character string, the document editing unit 203 acquires a placement region for an already placed tag, in step S803.

In step S804, the document editing unit 203 acquires a tag protruding direction, based on the page size acquired in step S802 and the tag placement region acquired in step S803. In step S805, the document editing unit 203 determines whether the tag protrudes in a specific direction based on the protruding direction acquired in step S804. If the tag does not protrude in a specific direction (NO in step S805), the processing proceeds to step S806. If the tag protrudes in a specific direction (YES in step S805), the processing proceeds to step S807.

In step S806, the document editing unit 203 sets the placement region calculated in step S803, for the character placement region of the annotation object information 410 acquired in step S801. The entire region of the tag placed on the page is set as the character placement region where a character string can be input.

In step S807, the document editing unit 203 acquires a page displacement width on the page preview 603 described above. The page displacement width is a displacement width between one page and another page illustrated in FIG. 6. The page displacement width may be a fixed value held by the document editing application 200 as a setting of this application, or the user may be enabled to set the page displacement width, using a setting dialog (not illustrated).

In step S808, the document editing unit 203 calculates a region where a character string can be displayed (a display enabled region) when the tag is present on a page other than the start page (when the page into which this tag is inserted is no longer the start page), based on the page size acquired in step S802, the tag placement region acquired in step S803, and the page displacement width acquired in step S807. In other words, the display enabled region corresponds to a region protruding from the page, of the region of the tag.

In step S809, the document editing unit 203 determines whether a character string is present, by referring to the text information 423 included in the annotation object information 410 acquired in step S801. If a character string is not present (NO in step S809), the processing proceeds to step S810. If a character string is present (YES in step S809), the processing proceeds to step S811.

In step S810, the document editing unit 203 sets the display enabled region calculated in step S808, in the character placement region 426 of the annotation object information 410 and the processing ends. Of the region of the tag, a region to be displayed without being hidden by another page can be set as the character placement region, by executing step S810.

In step S811, the document editing unit 203 calculates a region for rendering a character string on a tag (a text rendering region), by referring to the text information 423 and the font information 424 of the annotation object information 410. Specifically, the document editing unit 203 calculates how much area is to be used for rendering the character string, based on the font size and the number of characters of the character string.

In step S812, the document editing unit 203 compares the display enabled region acquired in step S808 and the text rendering region calculated in step S811, and thereby determines whether the display enabled region is larger than or equal to the text rendering region. If the display enabled region is larger than or equal to the text rendering region (YES in step S812), the processing proceeds to step S810. In step S810, the document editing unit 203 sets the display enabled region as the character placement region, and writes the character string in the set region. If the display enabled region is smaller than the text rendering region (NO in step S812), the processing proceeds to step S813. In step S813, the document editing unit 203 enlarges the tag in the protruding direction acquired in step S804 so that the display enabled region becomes larger than or equal to the text rendering region. When enlarging the tag, the document editing unit 203 may enlarge only the height of the tag, or only the width of the tag, or both of the height and the width of the tag. In step S814, the document editing unit 203 recalculates the display enabled region after the enlargement processing in step S813. Subsequently, in step S810, the document editing unit 203 sets the recalculated display enabled region as the character placement region.

The mode of enlarging the tag in step S813 for display is described, but a different mode may be adopted. For example, the tag may not be enlarged, and the font of the character string may be automatically adjusted, or the character string may be placed such that at least the leading portion of the character string is included (the trailing portion of the character string is not displayed).

### [Flow of Processing in Changing Displayed Page]

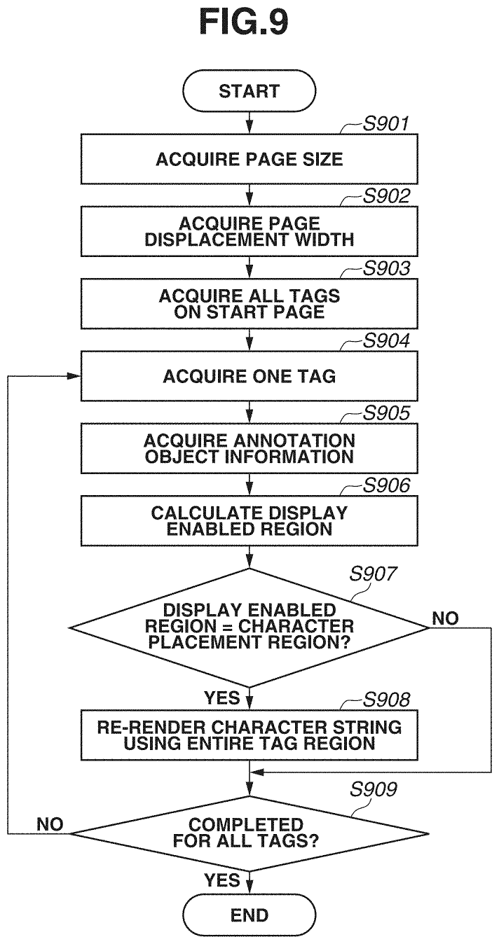

FIG. 9 is a flowchart illustrating a flow of processing about changing of a tag display method when a page displayed as the start page is changed in the page preview 603. The flow is executed after the placement of a character string is changed by the processing in FIG. 5 or FIG. 8 (in a case where the page into which the tag is inserted is a page other than the start page).

When the page 612 other than the start page is pressed by the user with the keyboard/mouse 108, the GUI unit 201 detects this operation on the keyboard/mouse 108 and provides an instruction corresponding to the operation to the input control unit 202. Upon receiving the instruction, the input control unit 202 instructs the document editing unit 203 to change the pressed page 612 other than the start page to the start page. Upon being instructed, the document editing unit 203 performs start-page change processing so that this processing flow begins.

In step S901, the document editing unit 203 acquires a page size from the page attributes of the page 611 that is an editing target and displayed in the page preview 603 as the start page. In step S902, the document editing unit 203 acquires a page displacement width on the page preview 603 as in step S807.

In step S903, the document editing unit 203 acquires the annotation object list 400 including all the tags present on the start page after the change. In step S904, the document editing unit 203 acquires one tag as a processing target from the annotation object list 400 including all the tags acquired in step S903. In step S905, the document editing unit 203 acquires the annotation object information 410 of the tag acquired in step S904. In step S906, the document editing unit 203 calculates a region where a character string can be displayed (a display enabled region) when the tag is present on a page other than the start page.

In step S907, the document editing unit 203 determines whether the character placement region 426 of the annotation object information 410 acquired in step S905 and the display enabled region calculated in step S906 are equal. If the document editing unit 203 determines that these regions are equal (YES in step S907), the processing proceeds to step S908. If the document editing unit 203 determines that these regions are not equal (NO in step S907), the processing proceeds to step S909. Whether step S810 in FIG. 8 is executed (whether this tag is the tag determined to protrude from the page in step S805) can be determined by executing step S907. In other words, in a case where the document editing unit 203 determines that the display enabled region and the character placement region are equal in step S907, it is clear that the tag acquired in step S904 is placed to protrude from the page. In a case where the document editing unit 203 determines that the display enabled region and the character placement region are not equal in step S907, it is clear that the tag acquired in step S904 is placed not to protrude from the page.

In step S908, the document editing unit 203 performs re-rendering to place the character string using the entire region of the tag. The re-rendering here does not refer to alignment of the character string to a side in a specific direction of the tag, but refers to rendering of the character string using the entire region of the tag. In step S909, the document editing unit 203 determines whether the processing is completed for all the tags in the list acquired in step S903. If the processing is completed for all the tags (YES in step S909), this processing flow ends. If the processing is not completed for all the tags (NO in step S909), the processing returns to step S904.

The character string in which the number of lines is increased by the processing in FIG. 8 can be placed in the entire region of the tag, by executing this flow triggered by changing the page where the tag is placed to the start page. The character string can be thereby viewed easily. On the other hand, for the tag placed on the page other than the start page, the character string can be displayed by using only the region protruding from the page, by executing the processing in FIG. 8.

### [Effects]

FIGS. 12A and 12B each illustrate an effect of the execution of the processing in FIG. 8. In either of FIGS. 12A and 12B, a state where a portion of the character string is covered by the start page due to the length of the character string (a tag 1203 and the tag 1207) is changed to a state where the character string is placed only in a tag region protruding from the page (a tag 1204 and a tag 1208).

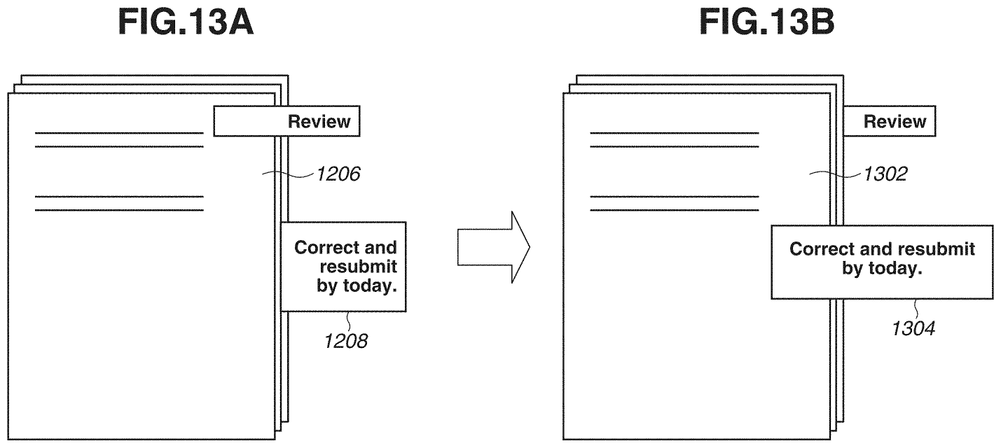

FIGS. 13A and 13B are diagrams illustrating an effect of the execution of the processing in FIG. 9.

FIG. 13A illustrates a state where the character string is fit in a tag region protruding from the page, by the processing in FIG. 8. FIG. 13B illustrates a state where the page to which the tag 1208 is attached is changed to the start page based on a selection operation by the user, and the character string is displayed over the entire tag region (a tag 1304).

Described in the first exemplary embodiment is the mode in which the placement position of the character string of the tag is shifted in a specific direction. Described in the second exemplary embodiment is the mode in which the character string is fit in the tag region protruding from the page. In a third exemplary embodiment, a method of switching between these two modes based on presetting will be described.

### [Tag Placement Setting]

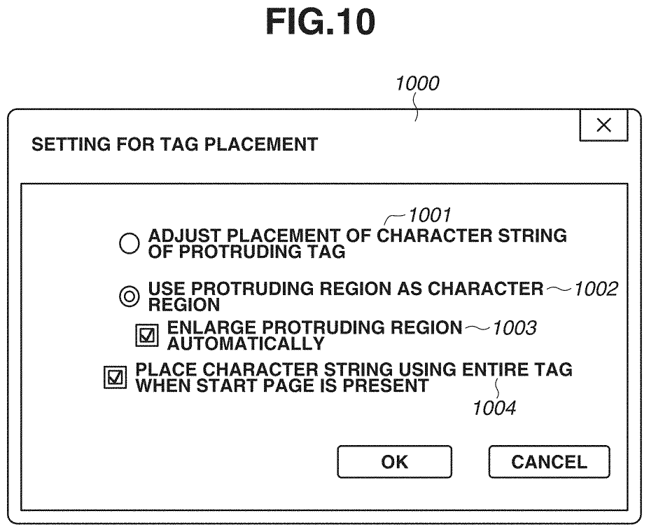

FIG. 10 illustrates a placement setting dialog 1000 for a tag, and this is an example of a user interface for setting in placing a tag. A radio button 1001 is a control for setting whether to align the placement position of a character string to the top, bottom, right, or left, when a tag is placed at such a position that the tag protrudes from the page. When this control is in a selection state, operation is similar to that in the first exemplary embodiment.

A radio button 1002 is a control for setting whether to place a character string only in a protruding region, when a tag protrudes from the page. A check box 1003 is a control that can be selected when the radio button 1002 is in a selection state. The check box 1003 is provided to set whether to enlarge a protruding region automatically, in a case where a character string placed only in a protruding region cannot be fit in the protruding region. When the radio button 1002 is in the selection state and the check box 1003 is also in the selection state, operation is similar to the operation of the flow of the processing about setting of the character placement region for the tag in the second exemplary embodiment. In a case where the check box 1003 is not selected, the mode of changing the font of the character string, or preventing the leading portion of the character string from being hidden by the start page, is enabled.

A check box 1004 is a control for displaying a character string of a tag placed on the start page, using the entire region of the tag. When this control is in a selection state, operation is similar to that of the flow (FIG. 9) of the processing in changing of the start page in the second exemplary embodiment.

A method of displaying the placement setting dialog 1000 may be any method. For example, a key or item for displaying the placement setting dialog 1000 may be provided on the menu/tool bar 602, or a key for displaying the placement setting dialog 1000 may be displayed by right-clicking the control 613 indicating “tag”.

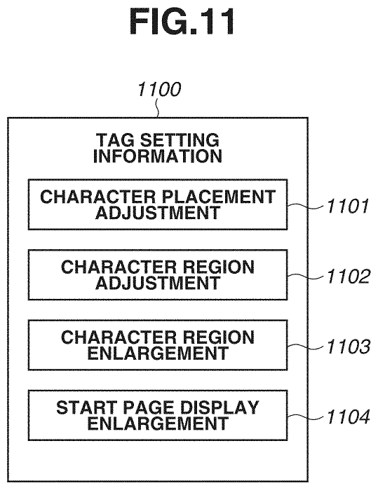

FIG. 11 illustrates a data structure of tag setting information 1100 set by the user in the placement setting dialog 1000. The tag setting information 1100 includes “character placement adjustment” information 1101, “character region adjustment” information 1102, “character region enlargement” information 1103, and “start page display enlargement” information 1104.

The “character placement adjustment” information 1101 corresponds to information to be set by the radio button 1001, and stores information about whether to align the placement position of a character string to the top, bottom, right, or left when a tag is placed at a position protruding from a page. The “character region adjustment” information 1102 corresponds to information to be set by the radio button 1002, and stores information about whether to place a character string only in a tag region protruding from a page.

The “character region enlargement” information 1103 corresponds to information to be set by the check box 1003, and stores information about whether to enlarge a protruding region automatically in a case where a character string cannot be fit in the region protruding from a page. The “start page display enlargement” information 1104 corresponds to information to be set by the check box 1004, and stores information about whether to display a character string using the entire tag region, for a tag included in the start page displayed in the page preview 603. The tag setting information 1100 is referred to, when a tag is generated and the generated tag is placed on a page by using the annotation specific information 407.

The user can select the alignment or placement region of a character string of a tag, or a mode for expression on the start page, by using the placement setting dialog 1000.

### Other Exemplary Embodiments

A mode different from the mode described with reference to step S810 in FIG. 8 of the second exemplary embodiment is conceivable. In the conceivable different mode, in a case where the display enabled region is larger than the text rendering region, the character string is aligned to a side in a direction in which the tag protrudes from the page, as described with reference to step S505 to step 506 and step S509 to step 510 in the first exemplary embodiment (FIG. 5).

Further, in each of the present exemplary embodiments, placing the character string as the content of the tag is described, but other types of content (e.g., an image) may be used.

The execution of the processing in each of FIG. 5 and FIG. 8 may be triggered by switching of display by a user operation from a state where a page to which a tag is attached is displayed as the start page in the foreground to a state where another page is displayed in the foreground. In that case, for example, the user attaches a tag to the start page such that the tag protrudes from the right side of the page, and inputs a character string into the tag to be left-aligned. Afterward, when the user performs a switching operation to display another page as the start page, the input character string being left-aligned is changed to the input character string being right-aligned.

According to the exemplary embodiments of the present disclosure, when a character string on an electronic tag is hidden in a plurality of pages displayed as a stack, it is possible to bring the character string into view without bothering a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2019-015846, filed Jan. 31, 2019, which is hereby incorporated by reference herein in its entirety.

What is claimed is:

1. An information processing apparatus including a display unit that displays a plurality of pages and an object attached to a page among the plurality of pages to have a portion protruding from a region of the page, the information processing apparatus comprising:
an input unit configured to input a character string to the object to align the character string to a side close to a starting position of the character string,
wherein, in a case where the portion of the object protrudes from a first page in a direction toward a side close to a termination position of the character string input by the input unit, the display unit displays the character string input by the input unit and aligned to the side close to the termination position of the character string.

2. The information processing apparatus according to claim 1, wherein, in a case where a second page is displayed to cover the first page, the display unit displays the character string input by the input unit and aligned to the side close to the termination position of the character string.

3. The information processing apparatus according to claim 2, wherein, in a case where a state where the second page is displayed to cover the first page is changed to a state where the first page is displayed in foreground without being covered by the second page, the character string aligned to the side close to the termination position of the character string and displayed by the display unit is displayed by using an entire region of the object.

4. The information processing apparatus according to claim 1, wherein the displayed character string aligned to the side close to the termination position of the character string is a character string displayed to fit in the portion protruding from the first page, of a region of the object.

5. The information processing apparatus according to claim 1, further comprising a determination unit configured to determine whether the character string is to be fit in the portion,
wherein, in a case where the determination unit determines that the character string is not to be fit in the portion, a portion of the character string is displayed in the portion protruding from a region of the page, of the object to display at least a leading portion of the character string.

6. The information processing apparatus according to claim 1, further comprising a determination unit configured to determine whether the character string is fit in the portion,
wherein, in a case where the determination unit determines that the character string is not to be fit in the portion, an area of the portion is increased.

7. The information processing apparatus according to claim 1, wherein the object is an electronic tag to be placed within the first page or having a portion to be placed outside a region of the first page.

8. A non-transitory storage medium storing instructions that when executed by one or more processors controls the one or more processors to operate as:
an information processing apparatus including a display unit that displays a plurality of pages and an object attached to a page among the plurality of pages to have a portion protruding from a region of the page, the information processing apparatus including
an input unit configured to input a character string to the object to align the character string to a side close to a starting position of the character string,
wherein, in a case where the portion of the object protrudes from a first page in a direction toward a side close to a termination position of the character string input by the input unit, the display unit displays the character string input by the input unit and aligned to the side close to the termination position of the character string.

9. A control method for an information processing apparatus including a display unit that displays a plurality of pages and an object attached to a page among the plurality of pages to have a portion protruding from a region of the page, the control method comprising:
inputting a character string to the object to align the character string to a side close to a starting position of the character string,
wherein, in a case where the portion of the object protrudes from a first page in a direction toward a side close to a termination position of the character string input in the inputting, the character string input in the inputting aligned to the side close to the termination position of the character string is displayed.
